(19) United States
(12) Patent Application Publication
(10) Pub. No.: US 2026/0037018 A1
(43) Pub. Date: Feb. 5, 2026

(54) PERFORMANCE CONTROL METHOD AND SYSTEM

(71) Applicant: GIGA COMPUTING TECHNOLOGY CO., LTD., New Taipei City (TW)

(72) Inventors: Bo Hui WU, New Taipei City (TW); Shih-Jay LIN, New Taipei City (TW); Hsin Teng FU, New Taipei City (TW); Yun-Ti CHEN, New Taipei City (TW)

(73) Assignee: GIGA COMPUTING TECHNOLOGY CO., LTD., New Taipei City (TW)

(21) Appl. No.: 18/902,083

(22) Filed: Sep. 30, 2024

(30) Foreign Application Priority Data
Jul. 30, 2024 (TW) 113128322

(51) Int. Cl. G06F 1/08

(52) U.S. Cl. CPC G06F 1/08

(57) ABSTRACT

A performance control method, performed by a baseboard management controller (BMC), includes: obtaining a sensed temperature of a processor or a pulse-width modulation (PWM) chip, determining whether the sensed temperature is greater than a default temperature, lowering a underclocking standard of the PWM chip for the processor and operating power of the processor when the sensed temperature is greater than the default temperature, and increasing the underclocking standard of the PWM chip for the processor and the operating power of the processor when the sensed temperature is not greater than the default temperature.

### CROSS-REFERENCE TO RELATED APPLICATIONS

This non-provisional application claims priority under 35 U.S.C. § 119(a) on Patent Application No(s). 113128322 filed in Republic of China (ROC) on Jul. 30, 2024, the entire contents of which are hereby incorporated by reference.

### BACKGROUND

### 1. Technical Field

This disclosure relates to a performance control method and system.

### 2. Related Art

Generally, when designing a server system, performance is preset based on the system configuration and adjusted according to the existing environment to meet system requirements. After the system boots up, the performance curve is manually adjusted based on the highest operating temperature.

However, this approach relies on manual setup and the generation of a binary file (bin file), which is then embedded into the basic input/output system (BIOS) to be loaded during boot-up for the desired performance. Additionally, this method introduces issues such as delayed response due to manual monitoring (e.g., adjusting only after the system temperature exceeds the preset range) and high development costs. For example, even after embedding the binary file into the BIOS, repeated testing by relevant personnel is still required.

### SUMMARY

Accordingly, this disclosure provides a performance control method and system.

According to one or more embodiment of this disclosure, a performance control method, performed by a baseboard management controller, includes: obtaining a sensed temperature of a processor or a pulse-width modulation chip; determining whether the sensed temperature is greater than a default temperature; lowering a underclocking standard of the pulse-width modulation chip for the processor and operating power of the processor when the sensed temperature is greater than the default temperature; and increasing the underclocking standard of the pulse-width modulation chip for the processor and the operating power of the processor when the sensed temperature is not greater than the default temperature.

According to one or more embodiment of this disclosure, a performance control system includes: a pulse-width modulation chip, a temperature sensor and a baseboard management controller. The temperature sensor is configured to perform sensing on a processor or the pulse-width modulation chip to generate a sensed temperature. The baseboard management controller is connected to the pulse-width modulation chip and the temperature sensor. The baseboard management controller is configured to determine whether the sensed temperature is greater than a default temperature, lower a underclocking standard of the pulse-width modulation chip for the processor and operating power of the processor when the sensed temperature is greater than the default temperature, and increase the underclocking standard of the pulse-width modulation chip for the processor and the operating power of the processor when the sensed temperature is not greater than the default temperature.

In view of the above description, performance control method and system according to one or more embodiments of the present disclosure may effectively control the performance of the server system, and may avoid the problem of delayed response caused by relying on human monitoring, and the development costs may be reduced.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram illustrating a performance control system according to an embodiment of the present disclosure;

FIG. 2 is a flowchart illustrating a performance control method according to an embodiment of the present disclosure; and

FIG. 3 is a flowchart illustrating a performance control method according to another embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

Please refer to FIG. 1, wherein FIG. 1 is a block diagram illustrating a performance control system according to an embodiment of the present disclosure. The performance control system 1 includes a processor A1, a temperature sensor 11, a pulse-width modulation (PWM) chip 12 and a baseboard management controller (BMC) 13. The BMC 13 is electrically connected to the processor A1, the temperature sensor 11 and the PWM chip 12. The PWM chip 12 may be further connected to the processor A1. The performance control system 1 may be adapted to a server system using water cooling and a server system using air cooling.

The processor A1 may include a central processing unit (CPU). The temperature sensor 11 may be disposed on one of the processor A1 and the PWM chip 12. The temperature sensor 11 is configured to sense the processor A1 or the PWM chip 12 to obtain a sensed temperature.

The PWM chip 12 may be configured to adjust the underclocking standard used on the processor A1. Further, the PWM chip 12 may be configured to store a current upper limit and a thermal design power value (TDP) of the processor A1, and may be controlled by the BMC 13 to adjust the stored current upper limit and the stored thermal design power value. In addition, the PWM chip 12 may be further configured to control the processor A1 to lower an operating frequency when determining that a working current of the processor A1 is greater than the current upper limit.

The BMC 13 may be implemented with a micro chip (MC) or an embedded controller. The BMC 13 is configured to adjust the operating standard of the processor A1 according to the sensing result of the temperature sensor 11 to obtain optimized performance, thereby increasing the overall computing capacity of the server system.

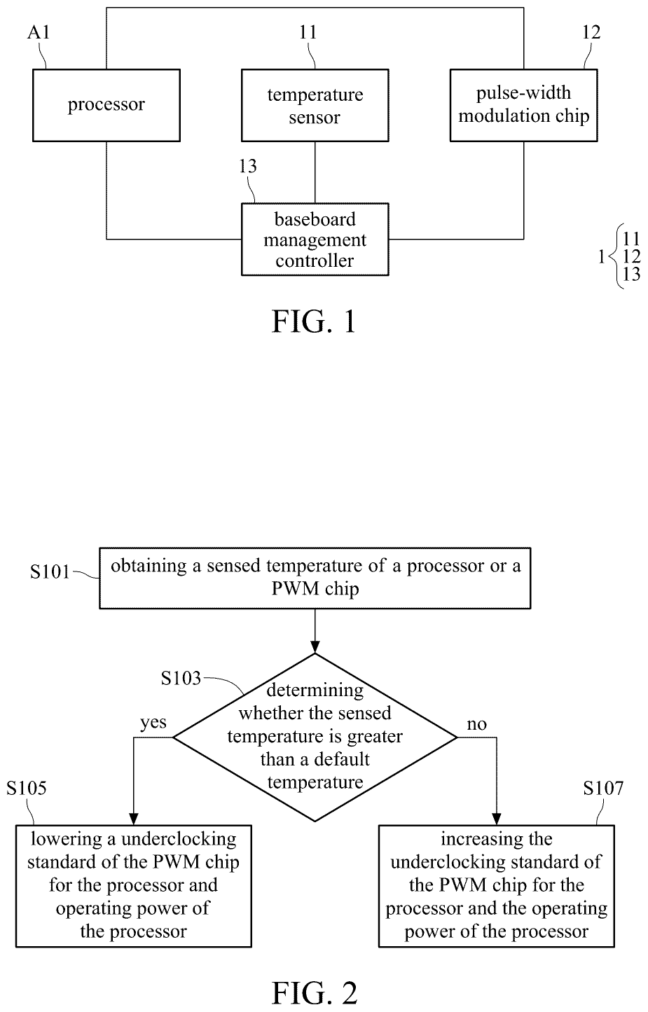

Please refer to FIG. 1 and FIG. 2, wherein FIG. 2 is a flowchart illustrating a performance control method according to an embodiment of the present disclosure. As shown in FIG. 2, the performance control method includes: step S101: obtaining a sensed temperature of a processor or a PWM chip; step S103: determining whether the sensed temperature is greater than a default temperature; when the determination result of step S103 is “yes”, performing step S105: lowering a underclocking standard of the PWM chip for the processor and operating power of the processor; and when the determination result of step S103 is “no”, performing step S107: increasing the underclocking standard of the PWM chip for the processor and the operating power of the processor. The following exemplarily uses the performance control system 1 shown in FIG. 1 to describe the steps of the performance control method shown in FIG. 2.

In step S101, the BMC 13 obtains the sensed temperature of the processor A1 or the sensed temperature of the PWM chip 12 from the temperature sensor 11.

In step S103, the BMC 13 determines whether the sensed temperature of the processor A1 or the sensed temperature of the PWM chip 12 is greater than the default temperature. The default temperature may be 80° C., but the present disclosure is not limited thereto.

When the BMC 13 determines that the sensed temperature of the processor A1 or the sensed temperature of the PWM chip 12 is greater than the default temperature, in step S105, the BMC 13 lowers the underclocking standard that PWM chip 12 has for the processor A1 (i.e. the underclocking standard that PWM chip 12 uses on the processor A1) and lowers or maintains the operating power of the processor A1, wherein the BMC 13 may perform step S105 through an intelligent platform management interface (IPMI) command.

The underclocking standard may include the current upper limit of the processor A1, the current upper limit may be stored in the PWM chip 12, and step S105 may include lowering the current upper limit stored in the PWM chip 12. The current upper limit may be a value of a maximum current that is allowed to flow through one or more elements in the processor A1 and the performance control system 1 and/or a value of a maximum current that is allowed to flow through the server system including the processor A1 and the performance control system 1. For example, the original current upper limit of the processor A1 is 233 ampere (A), and the original underclocking standard stored in the PWM chip 12 is 206 A, after the adjustment of step S105, the underclocking standard may be lower than 233 A. Further, the BMC 13 may multiply the original underclocking standard by a first default ratio, wherein the first default ratio is greater than 0 and is smaller than 1. By lowering the underclocking standard that PWM chip 12 has for the processor A1, the current flowing through the processor A1 may be lowered, thereby allowing the performance of the processor A1 to return to default performance.

In addition, the operating power of the processor A1 may correspond to the thermal design power value, and the thermal design power value is positively associated with a power consumption upper limit of the processor A1, and step S105 may include maintaining or lowering the thermal design power value stored in the PWM chip 12. In other words, the thermal design power value may indicate the power consumption upper limit that the processor A1 is not allowed to exceed. The PWM chip 12 may divide the thermal design power value by a second default ratio, wherein the second default ratio is equal to or greater than 1. For example, the original thermal design power value is 400 watt (W), and the PWM chip 12 may divide 400 W by 1 (the second default ratio) to obtain the thermal design power value of 400 watt. In other words, after step S105, the thermal design power value reported to the processor A1 by the PWM chip 12 may be the original or lowered thermal design power value. By maintaining or lowering the thermal design power value of the processor A1, the amount of computation performed by the processor A1 may be automatically lowered when the operating power of the processor A1 rises to the power consumption upper limit, thereby allowing the performance of the processor A1 to return to default performance.

When the BMC 13 determines that the sensed temperature of the processor A1 or the sensed temperature of the PWM chip 12 is not greater than the default temperature, in step S107, the BMC 13 increases the underclocking standard that PWM chip 12 has for the processor A1 (i.e. the underclocking standard that PWM chip 12 uses on the processor A1) and increases the operating power of the processor A1, wherein the BMC 13 may perform step S107 through IPMI command.

For example, the original current upper limit of the processor A1 is 233 A, the original underclocking standard stored in the PWM chip 12 is 206 A, and the underclocking standard after the adjustment of step S107 may be greater than 233 A. Further, the BMC 13 may multiply the original underclocking standard by a third default ratio, wherein the third default ratio is greater than 1. For example, the third default ratio is a value in the range of a value greater than or equal to 1.2 and another value smaller than or equal to 1.4. In other words, the underclocking standard after the adjustment of step S107 may fall in the range of 248 A and 290 A.

In addition, step S107 may include increasing the thermal design power value stored in the PWM chip 12. The PWM chip 12 may divide the thermal design power value by a fourth default ratio, wherein the fourth default ratio is greater than 0 and smaller than 1. For example, the fourth default ratio is a value in the range of a value greater than or equal to 0.81 and another value smaller than or equal to 0.99. For example, the original thermal design power value is 400 W, and the PWM chip 12 may divide 400 W by 0.81 (the fourth default ratio) to obtain the thermal design power value of 493 W. In other words, after the adjustment of step S107, the thermal design power value reported to the processor A1 by the PWM chip 12 may be the increased thermal design power value. By increasing the thermal design power value of the processor A1, the processor A1 may determine that the current power consumption of the processor A1 has not yet reached (is lower than) the power consumption upper limit, thereby allowing the processor A1 to perform more computation.

It should be noted that after step S105 and step S107, the BMC 13 may perform step S101 again. In addition, in step S105, the BMC 13 may further lower the underclocking standard of the PWM chip 12 and lower the operating power of the PWM chip 12; in step S107, the BMC 13 may further increase the underclocking standard of the PWM chip 12 and increase the operating power of the PWM chip 12. The method of adjusting the underclocking standard and the operating power of the PWM chip 12 may be the same as the method described above, and details thereof are not repeated herein.

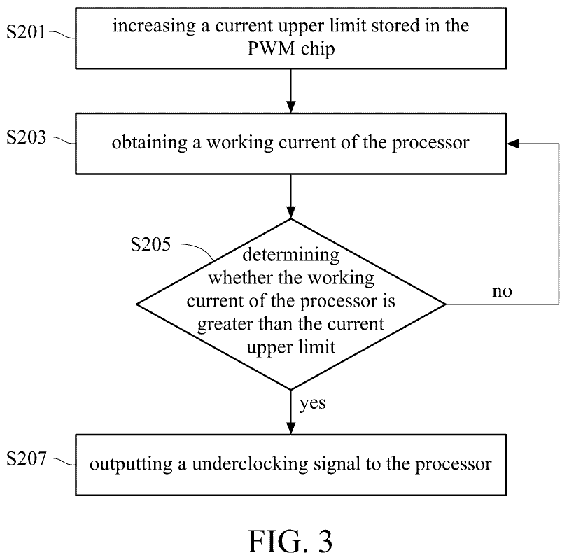

Please refer to FIG. 1 and FIG. 3, wherein FIG. 3 is a flowchart illustrating a performance control method according to another embodiment of the present disclosure. As shown in FIG. 3, the performance control method may include: step S201: increasing a current upper limit stored in the PWM chip; step S203: obtaining a working current of the processor; step S205: determining whether the working current of the processor is greater than the current upper limit; when the determination result of step S205 is “yes”, performing step S207: outputting a underclocking signal to the processor; and when the determination result of step S205 is “no”, performing step S203 again. Step S201 of FIG. 3 may be regarded as a detail flowchart of an embodiment of the PWM chip 12 increasing the underclocking standard for the processor A1 described in step S107 of FIG. 2. Steps S203, S205 and S207 of FIG. 3 may be performed after step S107 of FIG. 2.

In step S201, the BMC 13 increase the current upper limit of the processor A1 stored in the PWM chip 12.

In step S203, the BMC 13 obtains the working current of the processor A1. For example, the BMC 13 may be further connected to a current detector (for example, an amperemeter etc.), wherein the current detector is configured to detect the working current of the processor A1.

In step S205, the BMC 13 determines whether the working current of the processor A1 is greater than the current upper limit. The current upper limit is, for example, 90% of a default maximum working current of the processor A1 just shipped out from the factory, but the present disclosure is not limited thereto.

When the BMC 13 determines that the working current of the processor A1 is greater than the current upper limit, in step S207, the BMC 13 may lower the current level through an over current limit (OCL) pin to generate and output the underclocking signal to the processor A1, thereby notifying the processor A1 to down clock and lower loading thereof. On the contrary, when the BMC 13 determines that the working current of the processor A1 is not greater than the current upper limit, the BMC 13 may perform step S203 again to continue monitoring the working current of the processor A1.

In addition, in one or more embodiments described above, the BMC 13 may further obtain an optimization command input by the user through a basic input/output system (BIOS) interface, and perform step S101 of FIG. 2 after obtaining the optimization command. The optimization command may be configured to trigger the BMC 13 to perform step S101 of FIG. 2.

In view of the above description, performance control method and system according to one or more embodiments of the present disclosure may effectively control the performance of the server system, and may avoid the problem of delayed response caused by relying on human monitoring, and the development costs may be reduced. In addition, by increasing the underclocking standard of the PWM chip for the processor and the operating power of the processor, the overall computation capacity of the server system may be increased.

What is claimed is:

1. A performance control method, performed by a baseboard management controller, comprising:
obtaining a sensed temperature of a processor or a pulse-width modulation chip;
determining whether the sensed temperature is greater than a default temperature;
lowering a underclocking standard of the pulse-width modulation chip for the processor and operating power of the processor when the sensed temperature is greater than the default temperature; and
increasing the underclocking standard of the pulse-width modulation chip for the processor and the operating power of the processor when the sensed temperature is not greater than the default temperature.

2. The performance control method according to claim 1, wherein lowering the underclocking standard of the pulse-width modulation chip for the processor comprises lowering a current upper limit stored in the pulse-width modulation chip.

3. The performance control method according to claim 1, wherein increasing the underclocking standard of the pulse-width modulation chip for the processor comprises increasing a current upper limit stored in the pulse-width modulation chip, and the pulse-width modulation chip outputs a underclocking signal to the processor when the pulse-width modulation chip determines that a working current of the processor is greater than the current upper limit.

4. The performance control method according to claim 1, wherein increasing the operating power of the processor comprises increasing a thermal design power value stored in the pulse-width modulation chip, wherein the thermal design power value is positively associated with a power consumption upper limit of the processor.

5. The performance control method according to claim 1, further comprising:
obtaining an optimization command,
wherein obtaining the sensed temperature is performed after obtaining the optimization command.

6. A performance control system, comprising:
a pulse-width modulation chip;
a temperature sensor configured to perform sensing on a processor or the pulse-width modulation chip to generate a sensed temperature; and
a baseboard management controller connected to the pulse-width modulation chip and the temperature sensor, wherein the baseboard management controller is configured to determine whether the sensed temperature is greater than a default temperature, lower a underclocking standard of the pulse-width modulation chip for the processor and operating power of the processor when the sensed temperature is greater than the default temperature, and increase the underclocking standard of the pulse-width modulation chip for the processor and the operating power of the processor when the sensed temperature is not greater than the default temperature.

7. The performance control system according to claim 6, wherein the baseboard management controller lowering the underclocking standard of the pulse-width modulation chip for the processor comprises lowering a current upper limit stored in the pulse-width modulation chip.

8. The performance control system according to claim 6, wherein the baseboard management controller increasing the underclocking standard of the pulse-width modulation chip for the processor comprises increasing a current upper limit stored in the pulse-width modulation chip, and the pulse-width modulation chip outputs a underclocking signal to the processor when the pulse-width modulation chip determines that a working current of the processor is greater than the current upper limit.

9. The performance control system according to claim 6, wherein the baseboard management controller increasing the operating power of the processor comprises increasing a thermal design power value stored in the pulse-width modulation chip, wherein the thermal design power value is positively associated with a power consumption upper limit of the processor.

10. The performance control system according to claim 6, wherein the baseboard management controller obtains the sensed temperature after obtaining an optimization command.
